(19) United States
(12) Patent Application Publication
(10) Pub. No.: US 2024/0260679 A1
(43) Pub. Date: Aug. 8, 2024

(54) HEAT CONTROL FOR AEROSOL-GENERATING DEVICES

(71) Applicant: Philip Morris Products S.A., Neuchatel (CH)

(72) Inventors: Robin FARINE, Neuchatel (CH); Nicolas GUEVARA, Petit-Lancy (CH)

(73) Assignee: Philip Morris Products S.A., Neuchatel (CH)

(21) Appl. No.: 18/570,328

(22) PCT Filed: Jun. 23, 2022
(86) PCT No.: PCT/EP2022/067257

§ 371 Date: Dec. 14, 2023

(30) Foreign Application Priority Data
Jun. 24, 2021 (EP) 21181554.3

(51) Int. Cl. A24F 40/57; A24F 40/53; G05D 23/24

(52) U.S. Cl. CPC A24F 40/57; A24F 40/53; G05D 23/2401

(57) ABSTRACT

An aerosol-generating device is provided, including or being connectable to at least one heating element configured to heat at least a part of an aerosol-generating substrate usable with the aerosol-generating device to generate aerosol, the aerosol-generating device including: heat control circuitry configured to: receive at least one operational quantity associated with an operation of the at least one heating element, associate the at least one operational quantity to a plurality of classes, each class corresponding to a predefined characteristic of the at least one operational quantity, compute a score for each class, and determine a state indicator indicative of a heating state of the at least one heating element based on the plurality of classes and the computed scores for the classes. An aerosol-generating system including the aerosol-generating device, and a method of operating an aerosol-generating device, are also provided.

The present disclosure generally relates to the field of aerosol-generating devices and systems for generating aerosol. In particular, the present disclosure relates to an aerosol-generating device with heat control circuitry, to an aerosol-generating system comprising such aerosol-generating device, to a method of operating such aerosol-generating device or system, to a corresponding computer program, and to a computer-readable medium storing such program.

Aerosol-generating devices are typically designed as handheld devices that can be used by a user for consuming, for instance in one or more usage sessions, aerosol generated by an aerosol-generating article. Usually, aerosol-generating articles comprise an aerosol-generating substrate, for example a substrate containing tobacco material and/or a liquid. For generating the aerosol during use or consumption, heat can be applied or transferred from a heating element or heat source in the aerosol-generating device and/or in the aerosol-generating article to heat at least a portion of the aerosol-generating article and/or aerosol-generating substrate.

Exemplary aerosol-generating articles for use with aerosol-generating devices can comprise an aerosol-generating substrate that can be assembled, often with other elements or components, in the form of a stick. Such a stick-shaped aerosol-generating article can be configured in shape and size to be inserted at least partially into the aerosol-generating device. Other exemplary aerosol-generating articles can comprise a cartridge containing a liquid that can be vaporized during aerosol consumption by the user. The cartridge can be configured in shape and size to be inserted at least partially into the aerosol-generating device. Alternatively, the cartridge may be fixedly mounted to the aerosol-generating device and refilled by inserting liquid into the cartridge.

For generating the aerosol during use or consumption, heat can be supplied by a heating element or heat source to heat at least a part of the aerosol-generating substrate or article. Therein, the heating element can be arranged in the handheld device or a handheld part thereof. Alternatively or additionally, at least a part of or the entire heating element can be associated with or arranged within an aerosol-generating article, for instance in the form of a stick or cartridge, which can be attached to and/or powered by the aerosol-generating device.

Various forms and designs of heating elements and various heating techniques are currently used in the field of aerosol-generating devices and systems. Exemplary aerosol-generating devices can be configured to heat the aerosol-generating article or substrate based on resistive heating. Such devices typically comprise a resistance heating blade that acts as heating element and can be brought into contact with the aerosol-generating substrate or article, for example by at least partially inserting the blade into the substrate or article, and aerosol can be generated by resistively heating the heating blade. Alternatively one or more heating coils, for example arranged in or coupled to the aerosol-generating article or arranged in the aerosol-generating device, may be used for resistive heating.

Other exemplary aerosol-generating devices can be configured to heat the aerosol-generating article or substrate based on inductive heating. In one example, a susceptor or susceptor material is arranged in the aerosol-generating article or substrate, for example in the form of a planar metal band of ferromagnetic material at least partly surrounded by aerosol-generating substrate. Other forms of susceptor can include particles or flakes disposed within the aerosol-generating substrate or article. In another example, the susceptor is part of the aerosol-generating device. The aerosol-generating article or substrate can be inserted into the aerosol-generating device for aerosol consumption. Based on applying an alternating magnetic field to the susceptor, for example using one or more coils or inductive coils arranged in the aerosol-generating device, eddy currents (also called Foucault's currents) can be generated in the susceptor, thereby heating the susceptor and the aerosol-generating substrate in the vicinity thereof.

Yet other exemplary aerosol-generating devices can be configured to heat the aerosol-generating article or substrate based on microwave heating, for instance using a resonator, such as a loop-gap resonator, or other source of microwaves, such as a microwave generator, which can be arranged in the aerosol-generating device or the aerosol-generating article.

Generally, it may be favourable to heat the aerosol-generating substrate or article to a temperature, temperature region or temperature range appropriate for generating aerosol, which should substantially be constant or similar among various usage sessions to provide a consistent experience for the user, for example in terms of amount of aerosol generated, in terms of flavour and/or in terms of taste. Also, overheating of the aerosol-generating substrate or article (or parts thereof) should preferably be avoided, which could lead to the release of undesired substances from the substrate.

Therefore, it may be desirable to provide for an improved aerosol-generating device, for example providing improved heat control.

This is achieved by the subject-matter of the independent claims. Optional features are provided by the dependent claims and by the following description.

Aspects of the present disclosure relate to an aerosol-generating device, an aerosol-generating system with such aerosol-generating device, use thereof, a method of operating an aerosol-generating device or system, a corresponding computer program, and a computer-readable medium storing such program. Any disclosure presented hereinabove and hereinbelow with reference to one aspect of the present disclosure, equally applies to any other aspect of the present disclosure.

According to an aspect of the present disclosure, there is provided an aerosol-generating device configured to generate aerosol by or based on heating at least a part of an aerosol-generating substrate and/or an aerosol-generating article comprising an aerosol-generating substrate. The aerosol-generating device comprises or is connectable and/or couplable to at least one heating element configured to heat at least a part of an aerosol-generating substrate usable with the aerosol-generating device to generate aerosol. The aerosol-generating device includes heat control circuitry, the heat control circuitry being configured to receive and/or process at least one operational quantity associated with an operation of the at least one heating element. The heat control circuitry is further configured to associate and/or attribute the at least one operational quantity to a plurality of classes, each class corresponding to a predefined characteristic of the at least one operational quantity, and to compute a score for each class. Further, the heat control circuitry is configured to determine a state indicator indicative of a heating state of the at least one heating element based on the plurality of classes and the computed scores for the classes.

By associating the at least operational quantity with the heat control circuitry to a plurality of classes and calculating a corresponding score for each class to determine the state indicator, the heating state of the at least one heating element can be reliably, efficiently and quickly be determined. In particular, the heating state of the heating element, which may correlate with a temperature or a temperature region thereof, can be efficiently approximated and/or estimated based on associating the operational quantity with the classes and determining the scores for the classes. Thereby, fluctuations or uncertainties of the operational quantity can be smoothed, while information related to the heating state of the heating element can advantageously be preserved, which can result in a more precise determination of the current heating state of the heating element. In turn, the heating element can be controlled or operated precisely based on the determined state indicator, for example when compared to controlling the heating element based on the operational quantity itself. Also, overheating of the heating element or the aerosol-generating substrate can effectively be avoided.

The present disclosure is generally applicable to all techniques of heating that can be used to heat an aerosol-generating substrate or article to generate aerosol. This includes, for example, resistive heating, inductive heating and microwave heating, as discussed hereinabove. Accordingly, the aerosol-generating device and/or its heat control circuitry may be configured for one or more of resistive heating, inductive heating, and microwave heating.

The heat control circuitry may, for example, include one or more processors, one or more controllers or one or more micro-controllers for data processing. Optionally, at least a part of the heat control circuitry may be implemented on a printed circuit board. Alternatively or additionally, at least a part of the heat control circuitry may be implemented as smart chip or smart device. Alternatively or additionally, at least a part of the heat control circuitry may be implemented as application-specific integrated circuit, ASIC.

In an example, the at least one heating element can comprise one or more heating blades at least partially insertable into an aerosol-generating article or substrate for resistively heating the heating blade. For instance, the heat control circuitry can be configured to heat the heating blade or element based on supplying an electrical voltage and/or current to the heating blade.

Alternatively or additionally, the at least one heating element may comprise one or more coils or inductive coils for generating an alternating magnetic field interacting with a susceptor or susceptor material disposed withing the aerosol-generating substate or article. Therein, the heat control circuitry may be configured to drive the one or more coils, for example in a sequence of heating cycles.

Alternatively or additionally, the heating element can include a microwave source or generator, for example a resonator, such as a loop-gap resonator, which can be driven by the heat control circuitry to generate microwaves that can be used to heat the aerosol-generating substrate or article.

The at least one heating element or a part thereof may be comprised by and/or included in the aerosol-generating device. Alternatively or additionally, the at least one heating element or a part thereof may be comprised by and/or included in an aerosol-generating article couplable and/or connectable to the aerosol-generating device. For instance, at least a part of a heating coil or heating blade may be arranged in an aerosol-generating article, such as a cartridge-like or stick-shaped aerosol-generating article that can be coupled to and/or inserted into the aerosol-generating device. Alternatively or additionally, at least a part of a susceptor arranged in an aerosol-generating article may be considered as or may constitute the at least one heating element.

Alternatively or additionally, at least a part of the heating element may be arranged in an aerosol-generating article and at least one further part of the heating element may be arranged in the aerosol-generating device. For instance, one or more receiving coils of the at least one heating element may be arranged in an aerosol-generating article and one or more exciting coils of the at least one heating element may be arranged in the aerosol-generating device.

As used herein, the at least one operational quantity can relate or refer to an observable or parameter related to an operation or actuation of the at least one heating element by the heat control circuitry. Therein, an operation of the at least one heating element may refer to or include heating the at least one heating element and/or an aerosol-generating substrate or article. Accordingly, operating the at least one heating element can include actuating the heating element to generate heat and/or heating the heating element, the substrate and/or the article. For instance, the at least one operational quantity may be indicative of an electronic or electric behaviour or response of the at least one heating element during operation, actuation and/or heating of the at least one heating element. Any reference to the at least one operational quantity herein, can include or refer to a value of the at least one operational quantity.

The at least one operational quantity may, in the context of the present disclosure, be categorizable and/or classifiable, for example based on its value, in a plurality of categories that are referred to as classes herein. Each of the classes or categories can be descriptive, indicative or representative of a predefined characteristic or state of the at least one operational quantity, for example, within a predefined range of values of the operational quantity associated with the corresponding class. Accordingly, each class may be representative of the operational quantity having or exhibiting the corresponding characteristic and/or having a value associated with the corresponding class.

In a non-limiting and merely illustrative example, the at least one operational quantity may refer to or be indicative of a voltage supplied to the heating element. Conceivable classes for said operational quantity could, for example, comprise one or more of the classes high voltage, low voltage, positive voltage, negative voltage, increasing voltage, decreasing voltage, or the like.

The plurality of classes for the operational quantity can, for example, be empirically determined or chosen. For instance, the predefined characteristic of a class can be defined based on evaluating a curve or course of the operational quantity across a certain range of values of the quantity as a function of one or more further operational quantities, for example which may be involved in the operation or heating of the heating element.

As used herein, the score for each class can be indicative of the operational quantity being associateable or associated with the respective class and/or the corresponding predefined characteristic associated the respective class. Generally, the score for each class can be a numerical value or a binary value.

The heat control circuitry may be configured to compute or determine the score for each class based on processing and/or evaluating the operational quantity, for instance in terms of its value. In other words, computing the score for each class can include evaluating the at least operational quantity with respect to the classes associated with the operational quantity. For instance, the operational quantity or a corresponding value thereof can be mapped to the various classes by the heat control circuitry to determine the corresponding score for each class.

Accordingly, the at least one operational quantity or a value thereof can be represented and/or approximated by the plurality of classes and the scores for each class. As mentioned above, this can allow to compensate for fluctuations of the operational quantity or to smooth the operational quantity, for example over time, which can allow for a fast, reliable and efficient determination of the state indicator and hence the heating state.

As used herein, state indicator can be indicative of and/or descriptive of the heating state of the at least one heating element. Generally, the heating state of the heating element may be indicative of and/or correlate with a temperature, temperature region and/or temperature range of one or more of the at least a part of the heating element, the aerosol-generating substrate, and the aerosol-generating article heated by the heating element. Accordingly, the state indicator may refer to or denote a measure or quantity allowing for temperature control, as will be discussed in more detail hereinbelow.

In an example, the heat control circuitry may be configured to one or more of control a heating temperature of the at least one heating element based on the determined state indicator, activate the at least one heating element in order to initiate or increase aerosol generation based on the determined state indicator, and deactivate the at least one heating element in order to cease or reduce aerosol generation based on the determined state indicator. Optionally, the heat control circuitry may be configured to control a heating temperature of the at least one heating element based on comparing the determined state indicator to a predefined threshold value for the state indicator. Such threshold value for the state indicator may, for example, be stored in a memory or data storage of the aerosol-generating device or it retrieved from another data source, for example via a communication interface of the aerosol-generating device.

For instance, the heat control circuitry may be configured to control the heating temperature of the at least one heating element, activate the at least one heating element, and/or deactivate the at least one heating element based on controlling and/or adjusting one or more of a supply of energy to the at least one heating element, a duty cycle of the at least one heating element, and a driving frequency for driving the at least one heating element. Controlling the supply of energy and/or the duty cycle can comprise controlling and/or adjusting one or both of a supply voltage and a supply current. It is emphasized, though, that one or more other parameters or operational quantities can be controlled by the heat control circuitry, for example depending on the type of the heating element or depending on the technique applied for heating, such as inductive heating, resistive heating or microwave heating.

Further, the heat control circuitry may optionally be configured to deterministically compute the score for each class associated with the at least one operational quantity. As used herein, such deterministic computation may be contrasted with a computation based on artificial intelligence, for example using a neural network. Accordingly, the classification or categorization of the operational quantity into classes and the determination of the corresponding score may not be carried out using artificial intelligence. Hence, the scores for the classes can be determined with significantly reduced computing power, when compared to using artificial intelligence. Also, energy consumption and/or computation time can be reduced.

In an example, the score for each class associated with the at least one operational quantity may be indicative of a probability for the at least one operational quantity to fall in or into the respective class. In other words, the score for each class associated with the at least one operational quantity may be indicative of a probability for the at least one operational quantity to take, have, exhibit and/or adopt a value being in or being associateable with the respective class and/or the corresponding predetermined characteristic associated with the respective class. Alternatively or additionally, the score for each class can be indicative of a confidence level or confidence value for the operational quantity to fall in the respective class. In this context, the score for each class can be regarded as membership value indicating a degree or extent of the operational quantity being a member of or being associateable to the respective class. The probability may, for example, be given as a value between zero and one, between 0% and 100% or any other appropriate absolute or relative value range.

By way of example, the heat control circuitry may be configured to associate the at least one operational quantity to the plurality of classes and to compute the probability or score for each class based on a plurality of mathematical functions, each mathematical function mapping the score and/or the probability for one of the plurality classes to at least one of a predetermined scale and a predetermined range of the at least one operational quantity. Alternatively or additionally, each class associated with the at least one operational quantity may be represented by or given as a mathematical function mapping the probability for said class to at least one of a predetermined scale and a predetermined range of the at least one operational quantity. One or more of such mathematical functions can, for example, be stored in a memory or data storage, and can be used by the heat control circuitry to evaluate the operational quantity to compute the probability and/or score for each class.

One or more of such mathematical functions for one or more classes can, for example, be implemented in the aerosol-generating device in the form of a soft-coded equation or functional relationship. The at least one operational quantity may be used as input for the one or more mathematical functions to compute the corresponding score or probability. Alternatively or additionally, one or more of such mathematical functions can be implemented as look-up table, or the like.

For instance, at least some of the mathematical functions for at least some of the classes associated with the at least operational quantity can include at least one constant section, at least one triangular section, at least one trapezoidal section, at least one linear section, at least one curved section, at least one bell-curve section, and at least one sigmoidal section. Also any combination of such sections is possible. It is noted, though, that the present disclosure is not limited to mathematical functions having one or more of the aforementioned sections. In principle, any non-periodic function or any function allowing to unambiguously determine the probability or score for a class could be used as mathematical function in the context of the present disclosure.

The at least one operational quantity may, for example, be based on a measurement of the at least one operational quantity. Such measurement can be performed by the heat control circuitry, for example based on one or more sensors and/or based on determining or monitoring a supply voltage and/or current supplied by the heat control circuitry or a power supply thereof.

Alternatively or additionally, the at least one operational quantity can be derived from or determined based on a measurement of one or more further operational quantities associated with the operation of the at least one heating element. For instance, one or more further operational quantities, at least some of which may be measured, can be used to compute or calculate the at least one operational quantity.

In an example, the at least one operational quantity can be averaged over a predetermined period of time. For instance, the operational quantity can be sampled with a certain sampling frequency, wherein one sample value of the operational quantity can relate to or can be considered as average value of the operational quantity over the sampling time period.

As mentioned hereinabove, the at least one operational quantity can be indicative of an electrical behaviour of the at least one heating element during operation or actuation of the at least one heating element by the heat control circuitry. For example, the electrical behaviour or a response of the heating element may depend on or correlate with the operational quantity, which can allow for an accurate determination of the electrical behaviour based on the operational quantity.

By way of example, the at least one operational quantity may be indicative of one or more of a conductance, a conductance derivative, a conductance distance, a pulse shape of the conductance, a slope of the conductance, a resistance, a resistance derivative, a resistance distance, a power supplied to the at least one heating element, a power derivative, a duty cycle, a current supplied to the at least one heating element, and a voltage supplied to the at least one heating element. Such operational quantities may allow for a fast, reliable, and accurate determination of the heating state or state indicator, and hence for an accurate, fast, and reliable control of the heating element or its heating state.

Depending on the type of heating element or heating technique utilized, one or more of the aforementioned operational quantities can relate to one or more components of the heat control circuitry and/or the heating element, such as the heating element or a power supply of the.

For instance, when the heating is based on inductive heating, the heat control circuitry and/or the heating element may include one or more coils or inductive coils. In this example, operational quantities such as the conductance, the resistance and/or a derivative of one or both may allow to accurately determine the state indicator. Therein, the conductance or resistance may relate to a conductance or resistance of the one or more coils. Such physical or operational quantities can, for example, be determined based on measuring a voltage and/or current supplied to the one or more coils (or heating element) or absorbed by the one or more coils. By way of example, such measurement can be performed based on measuring a direct current supplied by the heat control circuitry or a power supply circuitry thereof. Alternatively, such measurement can be based on measuring an alternating current supplied to the one or more coils or heating element.

As used herein, the conductance distance, and likewise the resistance distance, can refer to a relative value of the conductance or resistance between predefined reference points on a conductance or resistance curve. Therein, the conductance or resistance curve can be indicative of the course of the conductance or resistance as a function of the heating state or another operational quantity related thereto or being involved in the heating of the heating element.

Similarly, the pulse shape or slope of the conductance can refer to a pulse shape or slope of the conductance as a function of the heating state, as a function of time and/or as a function of another operational quantity related to the heating state or being involved in the heating of the heating element.

In the exemplary and non-limiting use case of inductive heating, the conductance may be a varying function of the heating state of the heating element, which optionally may be indicative of or correlate with a temperature, a temperature region and/or a temperature range of the heating element. For instance, the conductance can evolve through a sequence of hills and valleys on a conductance versus heating state or temperature curve. Reference points on such curve can, for example, be a local maximum and a local minimum, for instance relating to a specific hill and valley on the curve, respectively. It is noted, though, that any other reference points on a conductance or resistance curve can be used to define the conductance distance or resistance distance, such as for example the distance between two local maxima or minima.

The heat control circuitry may be configured to receive a plurality of operational quantities, each operational quantity being associated with an operation of the at least one heating element. The heat control circuitry may further be configured to associate each one of the plurality of operational quantities to a plurality of classes, each class corresponding to a predefined characteristic of the at least one operational quantity, to compute a score for each class, and to determine the state indicator based on applying a set of one or more predefined rules to the determined plurality of classes and the corresponding scores and/or probabilities for the plurality of operational quantities. Therein, each rule may be indicative of an interrelation between at least one class of one of the plurality operational quantities and at least one class of at least one further operational quantity of the plurality of operational quantities. Alternatively or additionally, each rule may associate or correlate at least one class of one of the plurality operational quantities to at least one class of at least one further operational quantity. In an example, such interrelation between different classes of different operational quantities can be implemented as AND operation, as OR operation, a combination thereof or another operation.

Applying the set of predefined rules can advantageously allow to combine various different operational quantities or the information related to the heating state contained therein as reflected by the classes and corresponding scores or probabilities. In particular, applying the set of rules can allow for a fast computation of the state indicator at low computation power. Also, an accuracy of the state indicator can be increased and the overall heat control can be further improved.

In an example, the heat control circuitry may be configured to determine the state indicator based on combining partial state indicators determined by applying different rules of the set of predefined rules to the determined plurality of classes and the corresponding scores and/or probabilities for the plurality of operational quantities. Accordingly, the heat control circuitry may be configured to determine a partial state indicator based on applying a single rule of the set of rules to at least a subset of the determined plurality of classes and the corresponding scores and/or probabilities for the plurality of operational quantities.

Optionally, one or more of the partial state indicators may be used to determine the state indicator. For example, one or more of the partial state indicators can be selected as state indicator. Alternatively or additionally, a plurality of partial state indicators can be combined or merged to determine the state indicator.

In an example, the heat control circuitry may be configured to weight the partial state indicators with a rule-specific weighting quantity, weight factor or weight. One or more weights, weighting factors or weighting quantities can be predefined and for example stored in a memory of the device. Generally, the weights may reflect an importance or relevance of the corresponding rule for the determination of the state indicator. Hence, applying rule-specific weights can allow to account for a different importance or relevance of different rules for the determination of the state indicator and/or heat control.

By way of example, the state indicator and/or one or more partial state indicators can be given as, include and/or be indicative a temperature region. As used herein, a temperature region may correspond to a region or range of temperature, which the heating element's current temperature expectedly falls into. Determining a temperature region rather than determining the actual temperature may allow for a fast and efficient approximation of the actual temperature of the heating element at reduced computing power, in particular while retaining all information required for accurately controlling the heating element.

In an exemplary implementation, the state indicator may be given as the temperature region and a probability for an actual heating temperature of the at least one heating element to fall within or into the temperature region. For instance, a temperature region “hot” may be associated with a certain temperature and a probability of 0.8 may be determined for this temperature region. Accordingly, the heating element in this case would be in the “hot” region with a probability of 80%, or would be “at 80% hot”, and would be at 20% “non-hot” or in one or more other classes.

Optionally, a mathematical function mapping the probability of one or more temperature regions to a scale or range of temperature can be used to convert the determined probability and/or temperature region to an actual temperature of the heating element.

According to a further aspect of the present disclosure, there is provided an aerosol-generating system, which comprises an aerosol-generating device, as described hereinabove and hereinbelow, and an aerosol-generating article comprising an aerosol-generating substrate.

Any feature, function and/or element of the aerosol-generating device, described hereinabove and hereinbelow, equally applies to the aerosol-generating system, and vice versa.

Generally, any disclosure presented hereinabove and hereinbelow with reference to any aspect of the present disclosure, equally applies to any other aspect of the present disclosure.

A further aspect of the present disclosure relates to a use of an aerosol-generating device or system, as described hereinabove and hereinbelow, for generating aerosol.

Yet a further aspect of the present disclosure relates to a method of operating an aerosol-generating device or system, for example a device or system as described hereinabove and hereinbelow. The method comprises:
receiving and/or processing, with a heat control circuitry of the aerosol-generating device, at least one operational quantity associated with an operation of at least one heating element of the aerosol-generating device, the at least one heating element being configured to heat at least a part of an aerosol-generating substrate to generate aerosol and/or being couplable to the aerosol-generating device;
attributing and/or associating, with the heat control circuitry, the at least one operational quantity to a plurality of classes, each class corresponding to a predefined characteristic of the at least one operational quantity;
computing, with the heat control circuitry, a score for each class; and
determining, with the heat control circuitry, a state indicator indicative of a heating state of the at least one heating element based on the plurality of classes and the computed scores for the classes.

The method may further comprise one or more of controlling, with the heat control circuitry, a heating temperature of the at least one heating element based on the determined state indicator, activating the at least one heating element in order to initiate or increase aerosol generation based on the determined state indicator, and deactivating the at least one heating element in order to cease or reduce aerosol generation based on the determined state indicator.

Alternatively or additionally, the method may further comprise controlling, with the heat control circuitry, a heating temperature of the at least one heating element based on comparing the determined state indicator to a predefined threshold value for the state indicator.

Optionally, controlling the heating temperature of the at least one heating element, activating the heating element, and/or deactivating the heating element may comprise controlling one or more of a supply of energy to the at least one heating element, a duty cycle of the at least one heating element, and a driving frequency for driving the at least one heating element.

As described hereinabove, the score for each class may be indicative of a probability for the at least one operational quantity to fall into the respective class. Alternatively or additionally, determining the score for each class may comprise determining a probability for the at least one operational quantity to fall in the respective class.

In an example, attributing and/or associating the at least one operational quantity to the plurality of classes and computing the probability for each class may comprise evaluating the at least one operational quantity based on a plurality of mathematical functions, each mathematical function mapping the probability for one of the plurality classes to at least one of a predetermined scale and a predetermined range of the at least one operational quantity.

Optionally, the method can comprise one or more of measuring the at least one operational quantity with the aerosol-generating device, deriving the at least one operational quantity from a measurement of one or more further operational quantities associated with the operation of the at least one heating element, and averaging the at least one operational quantity over a predetermined period of time. Deriving the at least one operational quantity from the measurement may, for example, include computing the operational quantity based one or more measured operational quantities, which may differ from the at least one operational quantity. Further, averaging may, for example, include computing an average of the at least one operational quantity over the predetermined period of time.

In a further example, the method further comprises:
receiving a plurality of operational quantities, each operational quantity being associated with an operation of the at least one heating element;
associating each one of the plurality of operational quantities to a plurality of classes, each class corresponding to a predefined characteristic of the at least one operational quantity,
computing a score for each class; and
applying a set of one or more predefined rules to the determined plurality of classes and the corresponding scores and/or probabilities for the plurality of operational quantities, thereby generating a set of partial sate indicators.

Therein each rule may be indicative of an interrelation between at least one class of one of the plurality operational quantities and at least one class of at least one further operational quantity of the plurality of operational quantities. For example, at least a subset of the partial state indicators may be determined by applying different rules of the set of predefined rules. As used herein, receiving the at least one operational quantity or receiving a plurality of operational quantities may include processing the respective operational quantity with the heat control circuitry.

Optionally, the method may further comprise weighting, with the heat control circuitry, one or more partial state indicators with a rule-specific weighting quantity, weight or weight factor.

A further aspect of the present disclosure relates to a computer program, which when executed by an aerosol-generating device or an aerosol-generating system, instructs the aerosol-generating device or system to perform steps of the method, as described hereinabove and hereinbelow.

A further aspect of the present disclosure relates to a non-transitory computer-readable medium storing a computer program, which when executed by an aerosol-generating device or an aerosol-generating system, instructs the aerosol-generating device or system to perform steps of the method, as described hereinabove and hereinbelow.

Below, there is provided a non-exhaustive list of non-limiting examples. Any one or more of the features of these examples may be combined with any one or more features of another example, embodiment, or aspect described herein.

Example 1: An aerosol-generating device comprising or connectable to at least one heating element configured to heat at least a part of an aerosol-generating substrate usable with the aerosol-generating device to generate aerosol;
wherein the aerosol-generating device comprises heat control circuitry configured to:
   receive at least one operational quantity associated with an operation of the at least one heating element;
   associate the at least one operational quantity to a plurality of classes, each class corresponding to a predefined characteristic of the at least one operational quantity;
   compute a score for each class; and
   determine a state indicator indicative of a heating state of the at least one heating element based on the plurality of classes and the computed scores for the classes.

Example 2: The aerosol-generating device according to example 1, wherein the heat control circuitry is further configured to one or more of: control a heating temperature of the at least one heating element based on the determined state indicator; activate the at least one heating element in order to initiate or increase aerosol generation based on the determined state indicator; and deactivate the at least one heating element in order to cease or reduce aerosol generation based on the determined state indicator.

Example 3: The aerosol-generating device according to any one of examples 1 to 2, wherein the heat control circuitry is further configured to control a heating temperature of the at least one heating element based on comparing the determined state indicator to a predefined threshold value for the state indicator.

Example 4: The aerosol-generating device according to any one of examples 2 and 3, wherein the heat control circuitry is configured to control, activate, and/or deactivate the at least one heating element based on controlling one or more of a supply of energy to the at least one heating element, a duty cycle of the at least one heating element, and a driving frequency for driving the at least one heating element.

Example 5: The aerosol-generating device according to any one of examples 1 to 4, wherein the at least one heating element is based on at least one of inductive heating, resistive heating, and microwave heating.

Example 6: The aerosol-generating device according to any one of examples 1 to 5, wherein the heat control circuitry is configured to deterministically compute the score for each class associated with the at least one operational quantity.

Example 7: The aerosol-generating device according to any one of examples 1 to 6, wherein the score for each class associated with the at least one operational quantity is indicative of a probability for the at least one operational quantity to fall in the respective class.

Example 8: The aerosol-generating device according to example 7, wherein the heat control circuitry is configured to associate the at least one operational quantity to the plurality of classes and to compute the probability for each class based on a plurality of mathematical functions, each mathematical function mapping the probability for one of the plurality classes to at least one of a predetermined scale and a predetermined range of the at least one operational quantity.

Example 9: The aerosol-generating device according to example 8, wherein at least some of the mathematical functions for at least some of the classes associated with the at least operational quantity include at least one constant section, at least one triangular section, at least one trapezoidal section, at least one linear section, at least one curved section, at least one bell-curve section, and at least one sigmoidal section.

Example 10: The aerosol-generating device according to any one of examples 1 to 9, wherein the at least one operational quantity is based on a measurement of the at least one operational quantity.

Example 11: The aerosol-generating device according to any one of examples 1 to 10, wherein the at least one operational quantity is derived from a measurement of one or more further operational quantities associated with the operation of the at least one heating element.

Example 12: The aerosol-generating device according to any one of examples 1 to 11, wherein the at least one operational quantity is averaged over a predetermined period of time.

Example 13: The aerosol-generating device according to any one of examples 1 to 12, wherein the at least one operational quantity is indicative of an electrical behaviour of the at least one heating element during operation of the at least one heating element.

Example 14: The aerosol-generating device according to any one of examples 1 to 13, wherein the at least one operational quantity is indicative of one or more of a conductance, a conductance derivative, a conductance distance, a pulse shape of the conductance, a slope of the conductance, a resistance, a resistance derivative, a resistance distance, a power supplied to the at least one heating element, a power derivative, a duty cycle, a current supplied to the at least one heating element, and a voltage supplied to the at least one heating element.

Example 15: The aerosol-generating device according to any one of examples 1 to 14, wherein the heat control circuitry is configured to receive a plurality of operational quantities, each operational quantity being associated with an operation of the at least one heating element, to associate each one of the plurality of operational quantities to a plurality of classes, each class corresponding to a predefined characteristic of the at least one operational quantity, to compute a score for each class and to determine the state indicator based on applying a set of one or more predefined rules to the determined plurality of classes and the corresponding scores and/or probabilities for the plurality of operational quantities, each rule being indicative of an interrelation between at least one class of one of the plurality operational quantities and at least one class of at least one further operational quantity of the plurality of operational quantities.

Example 16: The aerosol-generating device according to example 15, wherein the heat control circuitry is further configured to determine the state indicator based on combining partial state indicators determined by applying different rules of the set of predefined rules to the determined plurality of classes and the corresponding scores and/or probabilities for the plurality of operational quantities.

Example 17: The aerosol-generating device according to example 16, wherein the heat control circuitry is configured to weight the partial state indicators with a rule-specific weighting quantity.

Example 18: The aerosol-generating device according to any one of examples 1 to 17, wherein the state indicator is given, include and/or be indicative of as a temperature region.

Example 19: The aerosol-generating device according to example 18, wherein the state indicator is given as the temperature region and a probability for an actual heating temperature of the at least one heating element to fall within the temperature region.

Example 20: An aerosol-generating system, comprising:
an aerosol-generating device according to any one of examples 1 to 19, and
an aerosol-generating article comprising an aerosol-generating substrate.

Example 21: A method of operating an aerosol-generating device, the method comprising:
receiving, with a heat control circuitry of the aerosol-generating device, at least one operational quantity associated with an operation of at least one heating element of the aerosol-generating device configured to heat at least a part of an aerosol-generating substrate to generate aerosol;
attributing, with the heat control circuitry, the at least one operational quantity to a plurality of classes, each class corresponding to a predefined characteristic of the at least one operational quantity;
computing, with the heat control circuitry, a score for each class; and
determining, with the heat control circuitry, a state indicator indicative of a heating state of the at least one heating element based on the plurality of classes and the computed scores for the classes.

Example 22: The method according to example 21, further comprising one or more of:
controlling, with the heat control circuitry, a heating temperature of the at least one heating element based on the determined state indicator,
activating the at least one heating element in order to initiate or increase aerosol generation based on the determined state indicator, and
deactivating the at least one heating element in order to cease or reduce aerosol generation based on the determined state indicator.

Example 23: The method according to any one of examples 21 to 22, further comprising:
controlling, with the heat control circuitry, a heating temperature of the at least one heating element based on comparing the determined state indicator to a predefined threshold value for the state indicator.

Example 24: The method according to any one of examples 22 and 23, wherein controlling, activating and/or deactivating the at least one heating element comprises controlling one or more of a supply of energy to the at least one heating element, a duty cycle of the at least one heating element, and a driving frequency for driving the at least one heating element.

Example 25: The method according to any one of examples 21 to 24, wherein the score for each class associated with the at least one operational quantity is computed deterministically.

Example 26: The method according to any one of examples 21 to 25, wherein the score for each class is indicative of a probability for the at least one operational quantity to fall in the respective class; and/or wherein determining the score for each class comprises determining a probability for the at least one operational quantity to fall in the respective class.

Example 27: The method according to example 26, wherein attributing the at least one operational quantity to the plurality of classes and computing the probability and/or score for each class comprises evaluating the at least one operational quantity based on a plurality of mathematical functions, each mathematical function mapping the probability for one of the plurality classes to at least one of a predetermined scale and a predetermined range of the at least one operational quantity.

Example 28: The method according to any one of examples 21 to 27, further comprising one or more of:
measuring the at least one operational quantity with the aerosol-generating device;
deriving the at least one operational quantity from a measurement of one or more further operational quantities associated with the operation of the at least one heating element; and
averaging the at least one operational quantity over a predetermined period of time.

Example 29: The method according to any one of examples 21 to 28, further comprising:
receiving a plurality of operational quantities, each operational quantity being associated with an operation of the at least one heating element;
associating each one of the plurality of operational quantities to a plurality of classes, each class corresponding to a predefined characteristic of the at least one operational quantity,
computing a score for each class; and
applying a set of one or more predefined rules to the determined plurality of classes and the corresponding scores and/or probabilities for the plurality of operational quantities, thereby generating a set of partial sate indicators, wherein each rule is indicative of an interrelation between at least one class of one of the plurality operational quantities and at least one class of at least one further operational quantity of the plurality of operational quantities.

Example 30: The method according to example 29, further comprising:
combining partial state indicators determined by applying different rules of the set of predefined rules.

Example 31: The method according to any one of examples 29 and 30, further comprising weighting, with the heat control circuitry, one or more partial state indicators with a rule-specific weighting quantity, weighting factor and/or weight.

Example 32: A computer program, which when executed by an aerosol-generating device or an aerosol-generating system, instructs the aerosol-generating device or system to perform steps of the method according to any one of examples 21 to 31.

33: Non-transitory computer-readable medium storing the computer program according to example 32.

Examples will now be further described with reference to the Figures in which:

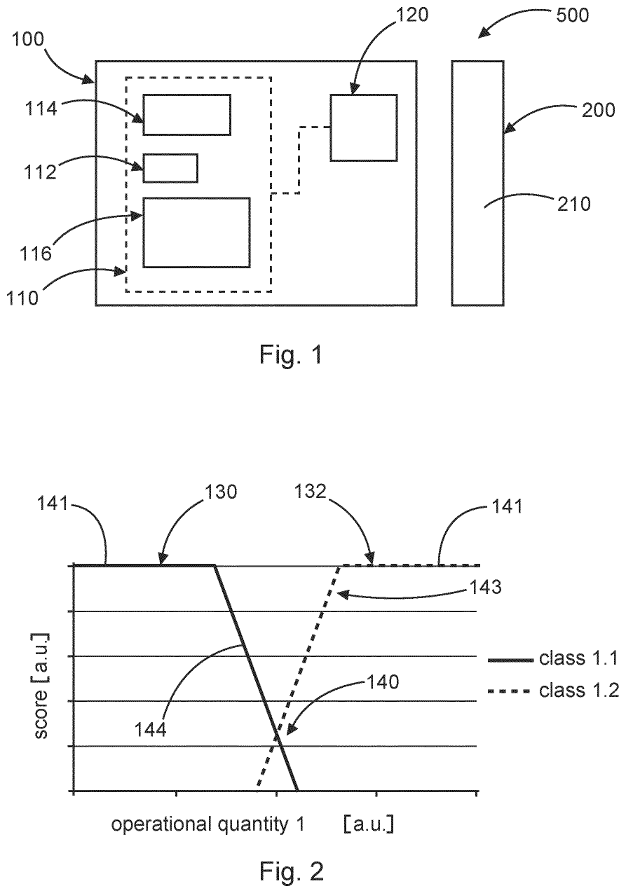

FIG. 1 shows an aerosol-generating system with an aerosol-generating device;

FIGS. 2 to 7 each illustrate aspects of determining a state indicator with an aerosol-generating device; and

FIG. 8 shows a flowchart illustrating a method of operating an aerosol-generating device or system.

FIG. 1 shows an aerosol-generating system 500 with an aerosol-generating device 100.

The system 500 of FIG. 1 further comprises an aerosol-generating article 200 with an aerosol-generating substrate 210. By means of the aerosol-generating device 100, aerosol can be generated based on heating at least a part of the substrate 210 or article 200.

The exemplary aerosol-generating article 200 depicted in FIG. 1 is stick-shaped and can be configured in shape and size to be inserted at least partially into the aerosol-generating device 100, for example via an opening of the aerosol-generating device 100. Other exemplary aerosol-generating articles 200 can comprise a cartridge containing a liquid that can be vaporized during aerosol consumption by the user. The cartridge can be configured in shape and size to be inserted at least partially into the aerosol-generating device 100. Alternatively, the cartridge may be fixedly mounted to the aerosol-generating device and refilled by inserting liquid into the cartridge.

For heating the aerosol-generating article 200 or substrate 210, the aerosol-generating device 100 comprises a heat control circuitry 110 and one or more heating elements 120. The heat control circuitry 112 is operatively coupled to the heating element 120 to control operation thereof, for example such that the heating element 120 can be heated to a predetermined temperature for generating aerosol.

The heat control circuitry 110 includes one or more processors 112 and optionally a memory 114 or data storage 114. For example, software instructions may be stored in the memory 114, which when executed by the one or more processors 112, instruct the device 100 to perform one or more functions, as described hereinabove and hereinbelow. Alternatively or additionally, the heat control circuitry 110 may include, or may be an application specific integrated circuit (ASIC).

The heat control circuitry 114 further comprises a power supply 116 providing electrical power to operate the device 100 and/or to heat the at least one heating element 120. Power supply 116 may, for example, comprise one or more batteries, accumulators and/or capacitors for supplying electrical power, for example in the form of DC or AC current, to the heating element 210. Alternatively or additionally, the aerosol-generating device 100 or power supply 116 may be powered via a supply grid or other energy source.

For example, the aerosol-generating system 500 can comprise a receiving device (not shown) the aerosol-generating device 100 can be coupled to for recharging the power supply 116.

The aerosol-generating device 100 and/or the heat control circuitry 110 may be configured for one or more of resistive heating, inductive heating and microwave heating. Accordingly, various forms and designs of heating elements 120 and heat control circuitries 110 are envisaged herein.

For instance, the aerosol-generating device 100 can be configured to heat the aerosol-generating article 200 or substrate 210 based on resistive heating, and the heating element 120 may comprise one or more resistive blades at least partially insertable into the substrate 210. Alternatively, the heating element 120 may comprise one or more heating coils that can be resistively heated by providing electrical power via the heat control circuitry 110 and/or the power supply 116. Such coils may be coupled to or may be part of, for example integrated in, the aerosol-generating article 200. Accordingly, at least a part of the heating element 120 and/or the heat control circuitry 110 may be integrated in the aerosol-generating article 200. This may for example be the case for a cartridge-like aerosol-generating article 200.

When the aerosol-generating device 100 is configured to heat the aerosol-generating article 200 or substrate 210 based on inductive heating, a susceptor or susceptor material may be arranged in the aerosol-generating article 200 or substrate 210, for example in the form of a planar metal band of ferromagnetic material at least partly surrounded by aerosol-generating substrate or in the form of particles or flakes disposed within substrate 210. In such configuration, the heating element 210 may comprise one or more inductive coils inducing eddy currents in the susceptor to heat the aerosol-generating substate 210 based on an alternating magnetic field.

For microwave heating, the heating element 120 may comprise one or more resonators or microwave generators to heat the aerosol-generating article 200 or substrate 210.

Depending on the type of heating utilized, one or more operational quantities may be involved in operating the heating element 120 or may be indicative of an operation thereof. For example, one or more operational quantities may be indicative of a heating temperature or heating state of the heating element 120 and/or the substrate 210.

To actually control an operation of the heating element 210, and for example adjust a temperature of the heating element 120, or to prevent the heating element 120 or substate 210 from overheating, the heat control circuitry 110 is configured to receive and/or process one or more operational quantities.

Exemplary operational quantities may include, but are not limited to, a conductance or resistance of the heating element 210 or other component of the heat control circuitry 110 such as the power supply 116. Alternatively or additionally, a derivative of the conductance or resistance, for example with respect to time or another operational quantity can be used operational quantity. Alternatively or additionally, a conductance or resistance distance can be used, for example a relative distance on a conductance or resistance versus heating state or temperature curve between two reference points on the curve. Alternatively or additionally, a pulse shape of the conductance or resistance, for example over time or as a function of another operational quantity, can be used as operational quantity. Alternatively or additionally, a slope of the conductance or resistance, for example with respect to time or another operational quantity, can be used as operational quantity. Alternatively or additionally, an electrical power, an electrical current, an electrical voltage supplied to the at least one heating element, a derivative from one or more of these, and/or a duty cycle can be used as operational quantity.

One or more of the operational quantities can be measured or determined by the heat control circuitry, for example based on determining and/or monitoring electrical power supplied via the power supply 116 to the heating element 120. Alternatively or additionally, the aerosol-generating device 100 may comprise one or more sensors for determining one or more operational quantities. Alternatively or additionally, one or more operational quantities may be determined based on, derived from or computed based on one or more other operational quantities.

The one or more operational quantities used for heat control or operation of the heating element 120 may be averaged or sampled over a predetermined period of time. This can allow to smooth short-term fluctuations in the determined quantities. Optionally, one or more previously sampled operational quantities can be used for or can be taken into consideration in the heat control of a current heating cycle.

Further, to control an operation of the heating element 210, and for example adjust a temperature of the heating element 120, or to prevent the heating element 120 or substate 210 from overheating, the heat control circuitry 110 is configured to associate each of the one or more operational quantities to a plurality of classes, wherein each class corresponds to or is indicative of a predefined characteristic of the respective operational quantity.

Further, the heat control circuitry 110 is configured to compute a score for each class associated with the respective operational quantity, and to determine a state indicator indicative of a heating state of the at least one heating element 120 based on the plurality of classes and the computed scores for the classes for the one or more operational quantities considered.

Therein, the state indicator and/or the heating state of the heating element 120 may correlate with or be indicative of a temperature, a temperature region, and/or a temperature range of the heating element 210.

Accordingly, based on attributing or associating the at least one operational quantity to a plurality of classes and determining the score for each class, the heating state can be estimated or approximated, thereby allowing to estimate or proximate the temperature, temperature region, and/or temperature range of the heating element 210. Preferably, one or more of the scores for at least one operational quantity considered may be non-zero.

Based on the determined state indicator, the heat control circuitry 110 may control a heating temperature of the at least one heating element 120. For example, the heating temperature of the at least one heating element 120 may be controlled based on comparing the determined state indicator to a predefined threshold value for the state indicator, which may be stored in memory 114. Alternatively or additionally, the heating temperature of the at least one heating element 210 may be controlled based on controlling one or more of a supply of energy to the at least one heating element 120, controlling the power supply 116, a duty cycle of the at least one heating element 120, and a driving frequency for driving the at least one heating element 120 or one or more components of the heat control circuitry 110, such as the power supply 116.

In an example, the score for each class associated with the at least one operational quantity can be indicative of a probability for the at least one operational quantity to fall in the respective class. Accordingly, the state indicator or heating state may be estimated or approximated based on determining a plurality of classes for each operational quantity considered and determining a probability for each class that may indicate a confidence level, extent or degree, to which the operational quantity (or a corresponding current value thereof) is within said class.

In a basic example, a voltage supplied to the heating element 120 may be considered as operational quantity. The voltage may be classified as “high voltage”, “low voltage”, and “medium voltage”, for example, and corresponding scores or values of 0.2, 0.2, and 0.6 may be determined for the classes based on current voltage supplied. This may be interpreted as the voltage supplied being 20% member of the classes “high voltage and low voltage”, and 60% member of the class “medium voltage”. In turn, this might indicate that the state indicator based on these classes and scores indicates an appropriate heating state for generating aerosol, in particular without overheating the heating element 120. It is emphasized that the aforementioned classification is illustrative only. Other classifications may, for example, include classes “negative voltage and positive voltage” or any other classification with a plurality of classes representing predetermined characteristics of the respective operational quantity.

In an exemplary implementation, the heat control circuitry 110 may be configured to associate one or more operational quantities to the plurality of classes and to compute the probability or score for each class based on a plurality of mathematical functions, each mathematical function mapping the probability or score for one of the plurality classes to at least one of a predetermined scale and a predetermined range of the at least one operational quantity.

FIGS. 2 to 6 each illustrate aspects of determining a state indicator (or partial state indicator) with an aerosol-generating device 100. In particular, each of FIGS. 2 to 6 illustrate a classification of an operational quantity, exemplary referred to as operational quantities 1 to 5 in FIGS. 2 to 6, based on a plurality of mathematical functions mapping the probability or score for each class to a predetermined scale and/or a predetermined range of the at least one operational quantity. The classes are exemplary denoted as class 1.1 to class 5.2 in FIGS. 2 to 6, wherein the first integer indicates the respective operational quantity and the second integer enumerates the classes associated with the respective operational quantity.

In FIGS. 2 to 6, the score is shown in arbitrary units versus the operational quantity (operational quantity 1 to 5) in arbitrary units across the range considered. A range considered for each operational quantity may be defined by a maximum and a minimum value of the operational quantity on the respective scale. Depending on the operational quantity, for example, the scale on which the operational quantity is considered may be a linear scale, a logarithmic scale or any other suitable scale.

As described above, the score for each class may be indicative of a probability for the operational quantity to have a value falling within or being associated with one or more of the classes. Such probability may be a value between zero and one, 0% and 100% or another appropriate value range.

The sum of scores for all classes of a single operational quantity, for example the scores for classes 1.1 and 1.2 of operational quantity 1, may be equal to a predefined maximum value.

In case of the scores relating to probabilities, the sum of the scores for a single operational quantity may, for example, equal one or 100%.

In the examples of FIGS. 2 to 6, a mathematical function, indicated by reference numerals 130 to 138, for each class of the respective operational quantity is shown. For reasons of simplicity, the classes shown in FIGS. 2 to 6 are referred to as “classes 1.1 to 5.2”. Depending on the operational quantity considered, however, the classes may correspond to certain characteristics of the operational quantity, as described above for the example of the voltage and the classes “high, low, and medium voltage”.

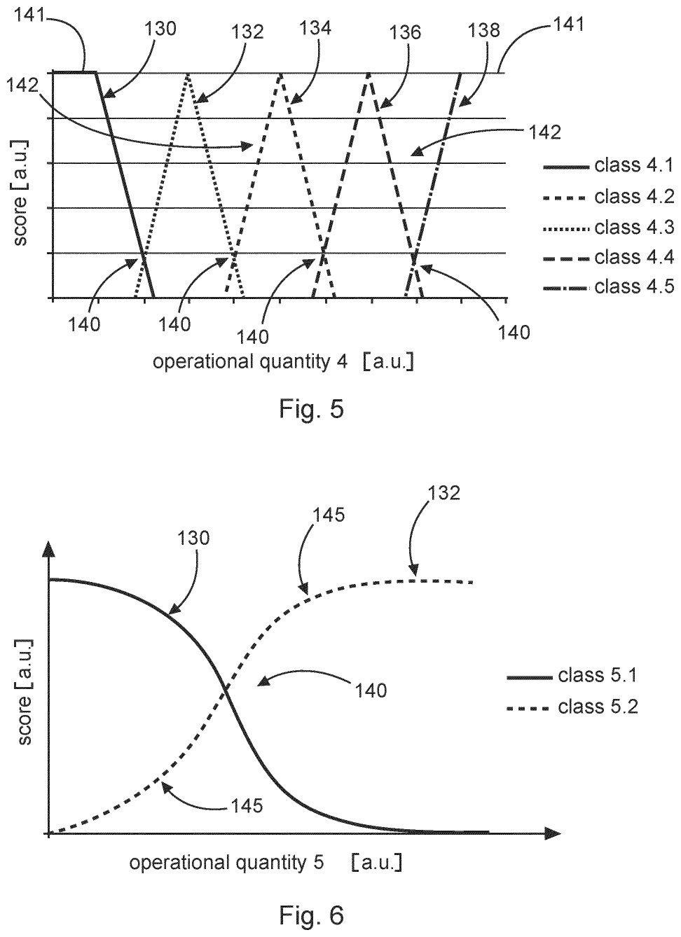

Further, depending on the operational quantity, two or more classes can be used for or be associated with the respective operational quantity. In the examples of FIGS. 2, 3, and 6, two classes (classes 1.1, 1.2, 2.1, 2.2, 5.1, 5.2) are associated with an operational quantity (operational quantity 1, 2, 5), whereas it is three classes (classes 3.1, 3.2, 3.3) in the example of FIG. 4 relating to operational quantity 3, and five classes (classes 4.1, 4.2, 4.3, 4.4, 4.5) in the example of FIG. 5 relating to operational quantity 4. Other numbers of classes are possible, though.

Preferably, at least two of the mathematical functions 130 to 138 associated with at least two different classes overlap in a certain range or region, as indicated by reference numeral 140 in FIGS. 2 to 6.

Further, as can be seen in FIGS. 2 to 6, for each value of the operational quantity, at least one score for at least one class is non-zero. In the overlap region(s) 140, a plurality of non-zero scores may be determined for the plurality of classes.

Various shapes and forms of mathematical functions can be used to describe a corresponding operational quantity based on classifying it into the respective classes and determining the score for each class. For example, each mathematical function can have one or more constant sections 141, at least one triangular section 142, at least one trapezoidal section 143, at least one linear section 144, and at least one curved section 145. Also other shapes or sections are possible, such as a one bell-curve section and a sigmoidal section.

As described hereinabove, based on the classes and the scores for each class of the one or more operational quantities, the heat control circuitry 110 can compute the state indicator (or one or more partial state indicators) indicative of the heating state of the heating element 120. For example, the state indicator or a partial state indicator may be a numerical value. For controlling the heating element 120, the determined state indicator may be compared to a threshold value. For example if the state indicator reaches or exceeds the threshold value, overheating may be detected by the heat control circuitry 110 and the heating element 120 may be turned off and/or a warning signal may be generated by the heat control circuitry 110.

Alternatively to the state indicator or partial state indicator being a numerical value, however, also the state indicator and/or partial state indicator may be determined based on associating the heating state to a plurality of classes, for example classes related to different temperature regions or states of the heating element 120, such as “very cold, cold, warm, hot, very hot”. Accordingly, the state indicator and/or the partial state indicator may be given as, include and/or be indicative of a plurality of classes and corresponding scores or probabilities for the classes, which can allow to estimate or approximate the actual temperature region for the heating element 120 similar to the aforementioned classification of the one or more operational quantities.

The heat control circuitry 110 may further be configured to determine a value of one or more operational quantities, a temperature, temperature range, and/or temperature region of the heating element 120 based on the determined state indicator and/or based on a plurality of partial state indicators.

For instance, an actual temperature, temperature region and/or temperature range of the at least one heating element 120 can be determined by defining a plurality of classes for the partial state indicators and/or the state indicator, each class being associated with an actual temperature, temperature region and/or temperature range. For example, classes “very cold, cold, warm, hot, very hot” could be defined for the partial state indicators and/or the state indicator by associating to each of these classes a range of temperatures in degrees (or another scale). Hence, the actual temperature of the heating element 120 can be determined based on the state indicator.

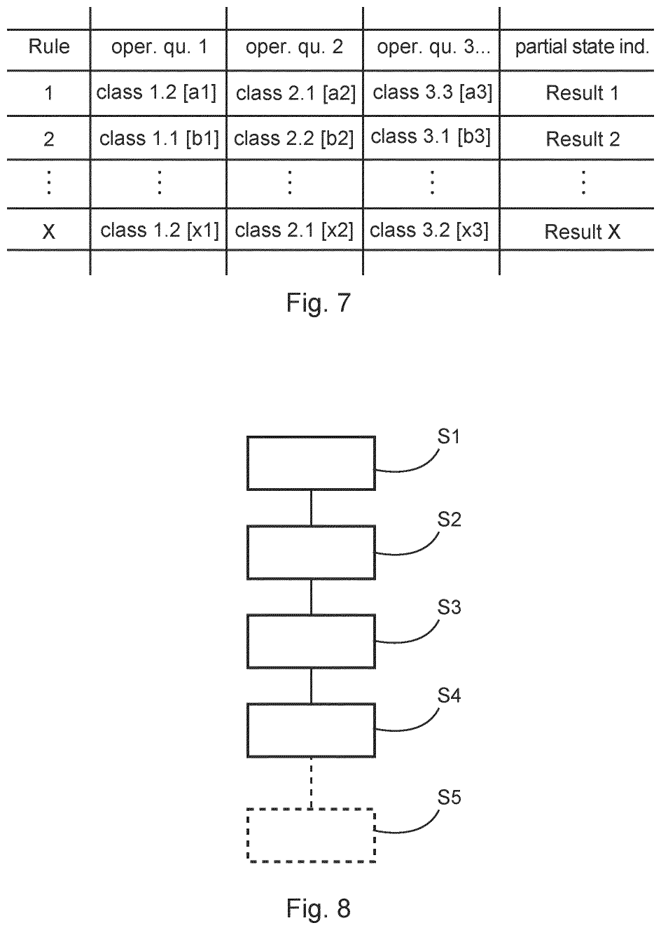

FIG. 7 illustrates another exemplary aspect of determining a state indicator and/or partial state indicator with an aerosol-generating device 100. In particular, FIG. 7 illustrates the application of a set of predefined rules 1, 2, . . . X to the determined plurality of classes for a plurality of operational quantities. Each line of the table shown in FIG. 7 corresponds to one rule.

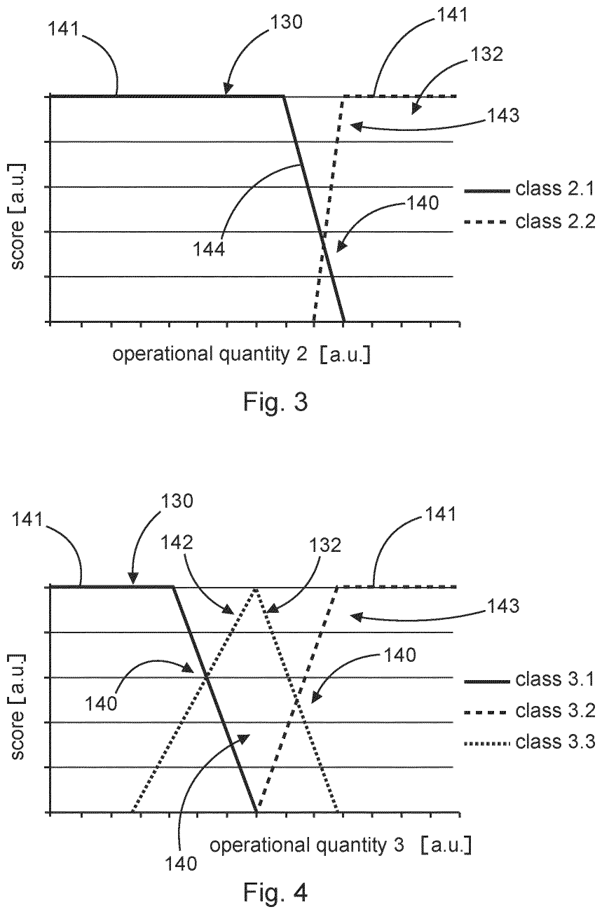

In the example of FIG. 7, operational quantity 1 of FIG. 2 with its classes 1.1 and 1.2, operational quantity 2 of FIG. 3 with its classes 2.1 and 2.2, and operational quantity 3 with its classes 3.1, 3.2, and 3.3 are considered (columns 2 to 4 of the table of FIG. 7) for illustrative purposes. It is noted, though, that additional, other or less operational quantities can be considered or taken into consideration.

Further, the table of FIG. 7 includes for each operational quantity 1 to 3 the corresponding class name (class 1.1 to class 3.3) and the corresponding score or probability shown in square brackets in columns 2 to 4 in FIG. 7, which score or probability has been determined as described hereinabove based on determining the respective operational quantities.

Depending on the rule, different classes and the corresponding scores or probabilities may be considered or taken into consideration. For example, rule 1 may take the score (score a1) of class 1.2 of operational quantity 1, the score (score a2) of class 2.1 of operational quantity 2, and the score (score a3) of class 3.3 of operational quantity 3 into consideration, whereas for rule x the score (score x1) of class 1.2 of operational quantity 1, the score (score x2) of class 2.1 of operational quantity 2, and the score (score x3) of class 3.2 of operational quantity 3 may be considered. Therein, each rule reflects an interrelation between the plurality of classes of the operational quantities considered. The selection of classes may be predefined for each rule or one or more criteria, for example defining which classes and scores are to be considered for which rule, can be predefined.

It is noted, though, that also a different metric or scheme may be applied for selecting which classes and scores are to be considered for which of the rule. For example, the classes with the highest scores, the lowest scores, or a medium score may be selected for each operational quantity and the corresponding rule may be applied to determine the partial state indicator for that rule. Also other metrics can be applied, for example one or more mathematical functions, to select the classes and scores that are to be considered for each rule.

Applying the rules to a plurality of classes and/or scores of a plurality of operational quantities can allow to combine or merge information from the plurality of operational quantities into the partial state indicators and/or the state indicator at low computational effort. In turn the aerosol-generating device 100 and/or the heating state of the heating element 120 can be accurately monitored and controlled based on the partial state indicators and/or the state indicator.

Accordingly, the state indicator or each of the partial state indicators can provide a summary or indication about the overall heating state of the heating element 120, for example containing information about a plurality of operational quantities. Hence, the heating state may be accurately reflected by the state indicator and/or the partial state indicators, which can allow for an accurate and quick control of the heating element 120.

In a non-limiting and merely illustrative example, the aerosol-generating device 100 and/or the heat control circuitry 110 can include a proportional-integral-derivative, PID, controller for controlling a temperature of the heating element 120. By determining the state indicator and/or the partial state indicators, the heat control circuitry 110 can monitor the heating state and control or guide the PID controller, for example towards an appropriate temperature or heating state of the heating element 120. Also, critical states, for example overheating, can be reliably and quickly detected, allowing to take appropriate countermeasures or actions based on controlling the PID controller and/or the heating element 120.

With continued reference to FIG. 7, the selected or determined classes and the corresponding scores or probabilities for each class (shown in square brackets in FIG. 7) can be evaluated based on the set of predefined rules 1, . . . , X. As noted above, each row in the table of FIG. 7 corresponds to the application of a single rule, which results in a corresponding partial state indicator, referred to as Result 1 to Result X in FIG. 7. Further, each rule may be indicative of or reflects an interrelation between the classes of the operational quantities considered for each rule.

For example, a rule may be implemented as AND condition, as OR condition, a combination thereof, or another condition. In the example shown in FIG. 7, using an AND operation may mean that class 1.2 with the respective score a1 of operational quantity 1 (column 2), class 2.1 with the respective score a2 of operational quantity 2 (column 3), and class 3.3 with the respective score a3 of operational quantity 3 are considered or combined to provide the partial state indicator “Result 1”.

Based on the partial state indicators and/or the state indicator, an actual temperature, temperature region and/or temperature range of the heating element 120 may be determined. For instance, each partial state indicator and/or the state indicator may be associated with a plurality of classes, each class being associated with or representing an actual temperature, temperature region and/or temperature range. For example, classes “very cold, cold, warm, hot, very hot” could be defined by associating to each of these classes a range of temperatures in degrees or on another scale.

Further, each partial state indicator as determined based on applying one of the rules (Result 1, . . . , Result X) and/or the state indicator determined based thereon may be indicative of one or more of the plurality of classes associated with the actual temperature, temperature region and/or temperature range of the heating element 120, and corresponding one or more scores for the classes.

In an example, partial state indicator “Result 1” could represent the class “warm” with a score of 0.5, meaning that the first partial state indicator is 50% warm. Further, application of the second rule leading to partial state indicator “Result 2” could represent the class “cold” with a score of 0.2, meaning that the heating element 120 is in the cold state to about 20%. Further, partial state indicator “Result X” could represent the class “hot” with a probability of 15%. Based on these partial state indicators, the heat control circuitry 110 may determine the state indicator, for example as class “warm” with a score of 45%.

It should be noted that each partial state indicator and/or the state indicator may also comprise a plurality of classes and corresponding scores for each of the classes. Alternatively or additionally, each of the partial state indicators and/or the state indicator may be converted into an actual temperature of the heating element 120 based on the one or more classes and the corresponding one or more scores.

Optionally, the partial state indicators as computed based on applying the set of predefined rules can be combined to compute the state indicator. For example, different partial state indicators may be summed, averaged, multiplied or otherwise used for calculating the state indicator.

To reflect different levels of relevance for each rule, the partial state indicators may be weighted with a rule-specific weighting quantity, weight or weighting factor.

FIG. 8 shows a flowchart illustrating a method of operating an aerosol-generating device 100 or system 500, for example in accordance with one or more of FIGS. 1 to 7.

In step S1, the heat control circuitry 110 of the aerosol-generating device 100 receives and/or processes at least one operational quantity associated with an operation of at least one heating element 120 of the aerosol-generating device 100 that is configured to heat at least a part of an aerosol-generating substrate 210 to generate aerosol.

In step S2, the heat control circuitry 110 associates or attributes the at least one operational quantity to a plurality of classes, each class corresponding to a predefined characteristic of the at least one operational quantity.

In step S3, the heat control circuitry 110 computes or calculates a score for each class, for example a probability as described hereinabove. Accordingly, determining the score for each class can comprise determining a probability for the at least one operational quantity to fall in the respective class.

One or more of steps S2 and S3 may optionally comprise evaluating the at least one operational quantity based on a plurality of mathematical functions, each mathematical function mapping the probability or score for one of the plurality classes to at least one of a predetermined scale and a predetermined range of the at least one operational quantity, for example as described with reference ton FIGS. 2 to 6.

In step S4, the heat control circuitry 110 determines a state indicator indicative of a heating state of the at least one heating element 120 based on the plurality of classes and the computed scores for the classes. Optionally a set of predefined rules can be applied in step S4 to the determined plurality of classes and the corresponding scores to determine partial state indicators, wherein the state indicator can be determined based on the partial state indicators, for example as described with reference to FIG. 7.

In an optional step S5, the heat control circuitry 110 may control a heating temperature of the at least one heating element based on the determined state indicator. This may comprise comparing the determined state indicator to a predefined threshold value for the state indicator. Alternatively or additionally, step S5 may comprise controlling one or more of a supply of energy to the at least one heating element 120, controlling a power supply 116, controlling a duty cycle of the at least one heating element 120, and controlling a driving frequency for driving the at least one heating element. 120.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1.-15. (canceled)

16. An aerosol-generating device, comprising or connectable to at least one heating element configured to heat at least a part of an aerosol-generating substrate usable with the aerosol-generating device to generate aerosol, the aerosol-generating device comprising:
heat control circuitry configured to:
receive at least one operational quantity associated with an operation of the at least one heating element,
associate the at least one operational quantity to a plurality of classes, each class corresponding to a predefined characteristic of the at least one operational quantity,
compute a score for each class, and
determine a state indicator indicative of a heating state of the at least one heating element based on the plurality of classes and the computed scores for the classes.

17. The aerosol-generating device according to claim 16, wherein the heat control circuitry is further configured to one or more of:
control a heating temperature of the at least one heating element based on the determined state indicator,
activate the at least one heating element in order to initiate or increase aerosol generation based on the determined state indicator, and
deactivate the at least one heating element in order to cease or reduce aerosol generation based on the determined state indicator.

18. The aerosol-generating device according to claim 16, wherein the heat control circuitry is further configured to one or more of control, activate, and deactivate the at least one heating element based on controlling one or more of a supply of energy to the at least one heating element, a duty cycle of the at least one heating element, and a driving frequency for driving the at least one heating element.

19. The aerosol-generating device according to claim 16, wherein the at least one heating element is based on at least one of inductive heating, resistive heating, and microwave heating.

20. The aerosol-generating device according to claim 16, wherein the score for each class associated with the at least one operational quantity is indicative of a probability for the at least one operational quantity to fall in the respective class.

21. The aerosol-generating device according to claim 20, wherein the heat control circuitry is further configured to associate the at least one operational quantity to the plurality of classes and to compute the probability for each class based on a plurality of mathematical functions, each mathematical function mapping the probability for one of the plurality classes to at least one of a predetermined scale and a predetermined range of the at least one operational quantity.

22. The aerosol-generating device according to claim 21, wherein at least some of the mathematical functions for at least some of the classes associated with the at least operational quantity include at least one constant section, at least one triangular section, at least one trapezoidal section, at least one linear section, at least one curved section, at least one bell-curve section, and at least one sigmoidal section.

23. The aerosol-generating device according to claim 16, wherein the at least one operational quantity is based on a measurement of the at least one operational quantity.

24. The aerosol-generating device according to claim 16, wherein the at least one operational quantity is derived from a measurement of one or more further operational quantities associated with the operation of the at least one heating element.

25. The aerosol-generating device according to claim 16, wherein the at least one operational quantity is indicative of an electrical behavior of the at least one heating element during operation of the at least one heating element.

26. The aerosol-generating device according to claim 16, wherein the at least one operational quantity is indicative of one or more of a conductance, a conductance derivative, a conductance distance, a pulse shape of the conductance, a slope of the conductance, a resistance, a resistance derivative, a resistance distance, a power supplied to the at least one heating element, a power derivative, a duty cycle, a current supplied to the at least one heating element, and a voltage supplied to the at least one heating element.

27. The aerosol-generating device according to claim 16, wherein the heat control circuitry is further configured to:
receive a plurality of operational quantities, each operational quantity of the plurality of operational quantities being associated with an operation of the at least one heating element,
associate each one of the plurality of operational quantities to a plurality of classes, each class corresponding to a predefined characteristic of the at least one operational quantity,
compute a score for each class, and
determine the state indicator based on applying a set of one or more predefined rules to the determined plurality of classes and the corresponding scores for the plurality of operational quantities, each rule being indicative of an interrelation between at least one class of one of the plurality operational quantities and at least one class of at least one further operational quantity of the plurality of operational quantities.

28. The aerosol-generating device according to claim 16, wherein the state indicator is given as a temperature region.

29. An aerosol-generating system, comprising:
an aerosol-generating device according to claim 16, and
an aerosol-generating article comprising an aerosol-generating substrate.

30. A method of operating an aerosol-generating device, the method comprising:
receiving, with a heat control circuitry of the aerosol-generating device, at least one operational quantity associated with an operation of at least one heating element of the aerosol-generating device configured to heat at least a part of an aerosol-generating substrate to generate aerosol;
attributing, with the heat control circuitry, the at least one operational quantity to a plurality of classes, each class corresponding to a predefined characteristic of the at least one operational quantity:
computing, with the heat control circuitry, a score for each class; and
determining, with the heat control circuitry, a state indicator indicative of a heating state of the at least one heating element based on the plurality of classes and the computed scores for the classes.
